(19) United States
(12) Patent Application Publication
(10) Pub. No.: US 2006/0165845 A1
(43) Pub. Date: Jul. 27, 2006

(54) Process for the preparation of a coffee product

(75) Inventors: Ko Kaku, Saitama-Ken (JP); Kevin Chandler, Basingstoke (GB)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 10/526,796

(22) PCT Filed: Oct. 15, 2003
(86) PCT No.: PCT/GB03/04451

§ 371 Date: Jan. 10, 2006

(30) Foreign Application Priority Data
Oct. 16, 2002 (GB) 0224111.5

(51) Int. Cl. A23F 5/00

(52) U.S. Cl. 426/45

(57) ABSTRACT

A process for the preparation of a coffee product comprising the step of compressing a roasted coffee in a roller press to form a compressed body of coffee. Preferably, the roller press is a briquetting press. Preferably, the compressed body of coffee is then crushed to provide an agglomerated and crushed particulate coffee having advantageous properties.

The present invention relates to a process for the preparation of a coffee product, and to products obtainable by means of the process.

It is known that the properties of coffee brewed from roasted and ground coffee beans can depend significantly on the particle size distribution of the ground coffee. For this reason, coffee grinders are conventionally provided with different settings for the preparation of filter coffee (coarse grind), espresso coffee (intermediate grind) and Turkish coffee (fine grind). In addition to the median particle size, and grinding method (e.g. milling versus flaking), the particle size distribution of the ground coffee particles is also significant. For example, EP-A-0554650 describes coffee for use in automatic espresso machines having a narrow particle size distribution around a median particle size of 195 to 240 μm. EP-A-0844195 describes a coffee for use in espresso brewing capsules, having a weighted average particle size of 300 to 650 μm, and only 5 to 10% of fine particles having a size less than 90 μm.

It is also known to provide compressed tablets of roasted ground coffee. Such tablets are a compact means of storing the coffee. The tablets disintegrate during brewing to allow extraction of the coffee. However, the formation of coffee tablets by compression has suffered from certain problems. Tablets compressed at low pressures (below about 40 Mpa) have poor mechanical integrity unless extraneous binder materials are introduced. Tablets compressed at high pressures (above about 60 Mpa) exhibit good mechanical integrity, because the high pressures extrude or express coffee oils and waxes from the particles, and the coffee oil and wax congeal to retain the particles in tablet form. However, the coffee brewed from such tablets exhibits a film of oil on the surface, and has other unsatisfactory characteristics.

High pressure tableting processes are described for example in U.S. Pat. No. 3,511,666. This patent describes the use of a permeable bag to enclose the tablet and capture the extruded oil so as to improve the brewing properties of the compressed coffee. Another high pressure process is described in CA-A-808588. This describes using a conventional tableting press at high pressure for a short time (less than 1 second) to minimise extrusion of coffee oils.

Low pressure coffee compaction is described in U.S. Pat. No. 3,607,299 and EP-A-0229920. In each case, the resulting tablet has rather poor mechanical integrity. It is enclosed within a brewing capsule, and may subsequently be disintegrated within the capsule.

It has now been found that coffee tableting can be carried out on a roller press to produce dense compacted coffee that is highly suitable for subsequent processing into coffee beverages having excellent appearance and taste.

Accordingly, in a first aspect the present invention provides a process for the preparation of a coffee product comprising the step of compressing a roasted coffee in a roller press to form a compressed body of coffee.

The term “roller press” refers to an apparatus for compacting particulate material into shaped products by compression against one, and preferably between two rollers. The term “roller press” includes roller compactors and briquetting presses. Preferably, two rollers are mounted on substantially parallel, preferably substantially horizontal axes. Preferably, at least one roller has a profiled or pocketed surface for forming the compacted bodies of coffee. More preferably, the press comprises two rollers having complementary recesses or pockets on their surfaces for forming the compacted bodies. Such presses are available, for example, from Hosokawa Bepex GmbH, of Leingarten, Germany. Roller presses have been widely used for processing coal dust and iron ore into briquettes, and for medical tableting, agglomerating and granulating. They have also been used in the manufacture of confectionery, especially chewing gum.

The compaction of coffee into compressed bodies on a roller press is essentially a dynamic process, and it is therefore difficult to specify a unique tableting pressure. However, the effective tableting pressure is probably greater than about 50 Kpa, and also probably greater than about 60 KPa, since the resulting compressed coffee preferably has a density greater than about 0.95 g/cm², more preferably greater than about 1.0 g/cm². For example, the compressed coffee preferably sinks when dropped into cold water.

The coffee is formed into compressed bodies by the press. That is to say, it is formed into self-supporting shaped structures that preferably consist essentially of coffee.

Preferably, the process results in compressed bodies of coffee having a weight of from about 0.5 to about 20 g, more preferably from about 1 to about 5 g. Typically, the compressed bodies do not have flat opposed surfaces of the kind produced in conventional presses. Typically, the bodies have curved front and back surfaces, frequently these surfaces are symmetrical about median plane. Suitable shapes include pillow shapes and finger shapes, for example finger shapes having a length of from about 2 to about 15 cm, a width of from about 0.3 to about 3 cm, and a depth from about 0.3 to about 3 cm.

The roasted and ground coffee used as the starting material may comprise whole coffee beans or particles thereof. Preferably, the starting material is a ground or flaked coffee. Coffee mills are well known in the art, and will not be described further here. Typically, a starting coffee has a weighted average particle size D(4,3) as determined by light scattering in n-butanol using a Malvern Instruments Mastersizer 2000 of from about 300 μm to about 600 μm. Typically, the volume percent of fines of size less than 100 μm determined by the same method is from about 10% to about 50%, preferably from about 20% to about 40%. The particulate coffee starting material typically has a tap density about 0.4 g/cm³ to about 0.5 g/cm³.

Typically, the duration of the compression of the coffee in the rotary press is short, for example less than 5 seconds, preferably less than about 2 seconds, and more preferably less than about 0.5 seconds. This results in effective compaction of the coffee to form a dense compressed body, with low extrusion of oils. It is also an efficient high-throughput compaction technique.

The organoleptic properties of the resulting coffee can be further improved by the application of cooling during the process. This helps to counteract the heating effect of the compression (and subsequent optional crushing), which can otherwise raise the temperature of the coffee to 40-50° C. or more. In certain embodiments, the cooling is applied to the coffee before it enters the process, for example the coffee beans entering the process may be cooled below ambient temperature, for example in a cooled hopper. The ground coffee may be cooled before it enters the roller press, again for example by use of a cooled hopper. In especially preferred embodiments, the roller of the roller press is cooled, for example by passing a refrigerated liquid through a cooling loop inside the roller, thereby minimising the heating of the tablets. Preferably, the hopper and/or the rollers are cooled to a temperature just above the dew point of the ambient atmosphere, for example 10° C. to 20° C., preferably about 11° C. to about 14° C.

Preferably, the process according to the present invention further comprises the step of crushing the coffee tablet to form a particulate coffee product. The term “crushing” includes any method of comminuting the coffee bodies, including conventional mills. Crushing is preferably carried out in a granulator mill having a cylinder rotating in a U-shaped mesh. The crushed product typically has a different particle size distribution and tap density than the starting material. For example, the reground product typically has a higher fines content and a higher tap density than the initial coffee. In addition, the agglomerated and crushed product has a different flavour profile. It seems that the predominant taste characteristic of the starting material is accentuated in the processed coffee. For example, bitter coffee becomes more bitter, and so forth. The brewing properties are also changed, even if the weighted median particle size is similar to the initial material. Preferably, the agglomerated and crushed particulate coffee has a volume weighted average particle size D(4,3) in the range of from about 200 to about 600 μm. Preferably, the fines content below 100 μm as hereinbefore defined is greater than about 35% by volume. Preferably, the tap density of the agglomerated and crushed coffee is at least 20% higher than that of the coffee before compression. Preferably, the tap density of the agglomerated and crushed coffee is greater than 0.45 g/cm³, more preferably greater than about 0.55 g/cm³.

Preferably, the process according to the present invention further comprises a step of packaging the compressed coffee body, or the crushed particulate coffee, in a brewing capsule. The brewing capsule may, for example, be formed of a liquid permeable material, for example a spun bonded polyester or nylon of the kind conventionally used for coffee bags. In preferred embodiments, the brewing capsule is formed from substantially air- and moisture-impermeable sheet material. For example, the sachets described in GB-A-2121762, EP-A-0179641 or WO99/05036. Other preferred formats are the espresso coffee brewing capsules, for example as described in WO93/17932 or WO94/02059. The entire content of these documents is expressly incorporated herein by reference.

It is an advantage of the process according to the present invention that the crushed particulate coffee has a higher tap density than conventional flaked ground coffee. This enables a standard amount of coffee to be packaged in a smaller sachets, thereby saving on packaging materials. It also enables larger amounts of coffee (e.g. 10 g) to be packaged in a standard sachet, thereby enabling stronger brews and larger-size cups. Especially high packaging densities can be achieved by introducing the compressed bodies directly to the brewing sachet. The compressed bodies may optionally be broken up within the sachet, for example by passing the sachet through rollers.

Accordingly, further aspects of the present invention provide a coffee tablet obtainable by a process according to the present invention, a particulate coffee obtainable by such a process including a crushing step, and a coffee brewing capsule obtainable by a process according to the present invention.

An embodiment of the present invention will now be described further, by way of example, with reference to the accompanying drawings, in which:—

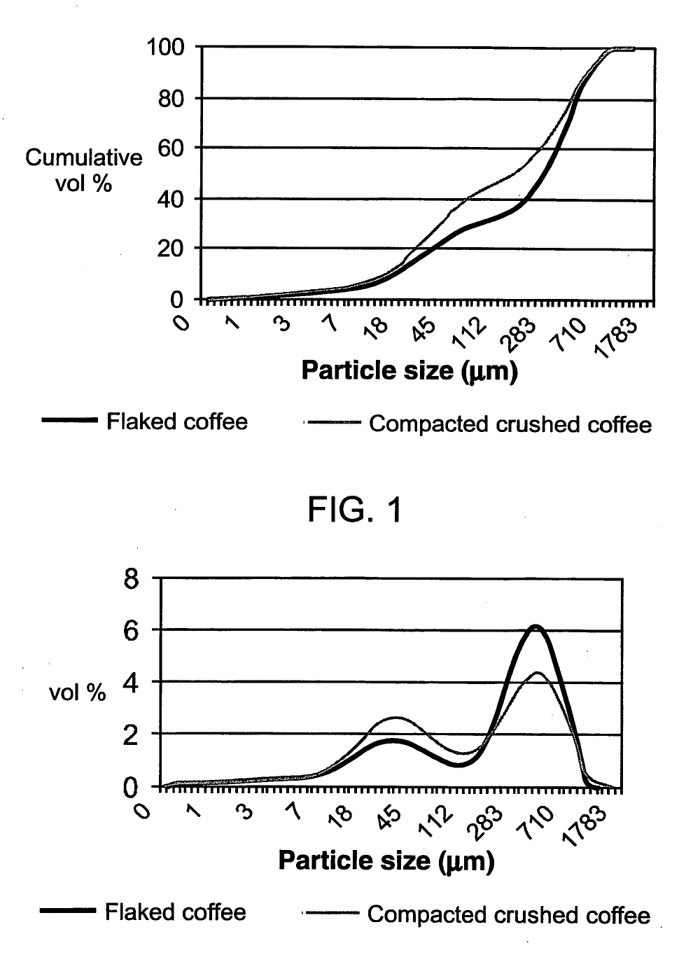

FIG. 1 shows a measured particle size distribution for a roasted and flaked coffee starting material for comparison, and for the same coffee following compaction and crushing in accordance with the present invention;

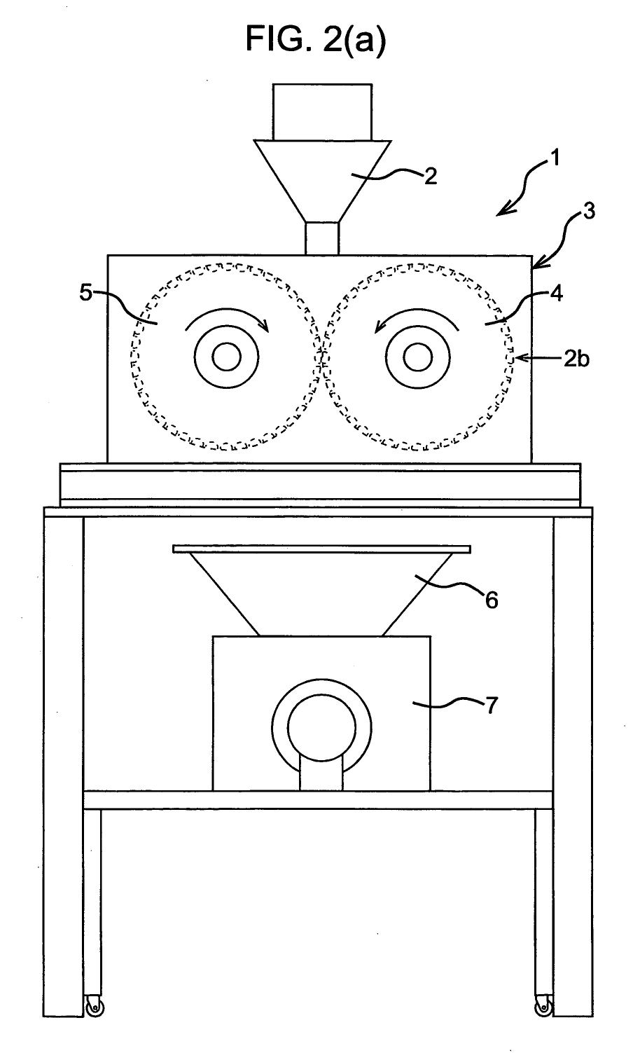

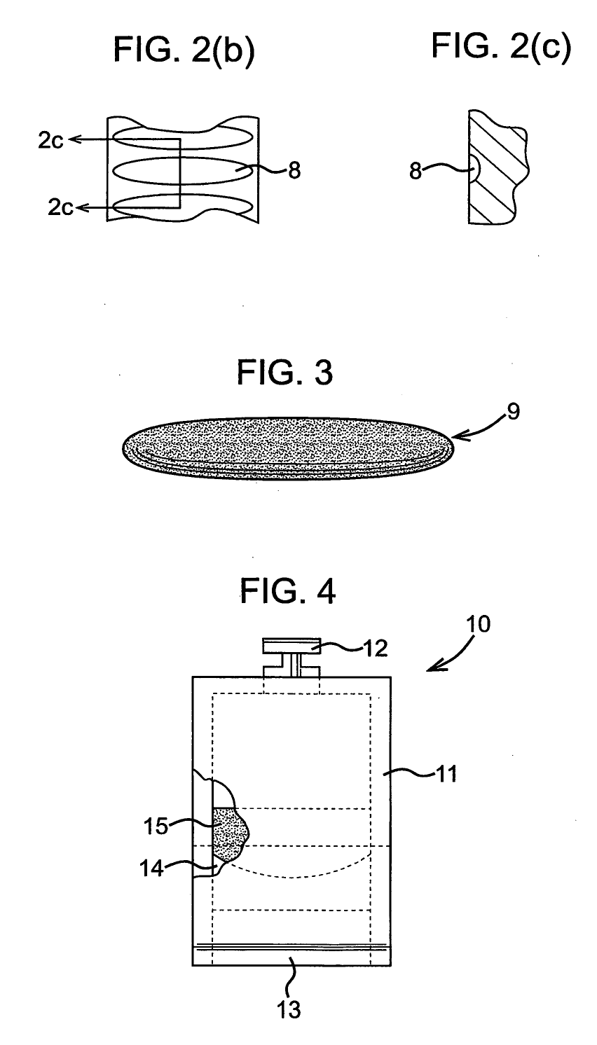

FIGS. 2(a)-(c) show a side elevation view of a briquetting press and crusher for use in the invention, with detail views of the pocketed rollers of the briquetting press;

FIG. 3 shows a compressed body of coffee produced by the process; and

FIG. 4 shows a coffee brewing capsule-according to the invention.

### EXAMPLE 1

A Sumatran coffee is roasted and flaked to provide a ground coffee having the particle size distribution shown in FIG. 1, as determined laser light scattering in n-butanol at 25° C. using a Malvern Mastersizer 2000 (Malvern Instruments, Malvern, UK). It can be seen that the particle size distribution has a principal peak around 400 μm, and a volume fraction of approximately 33% of fines having a size less than 100 μm.

The flaked coffee is then introduced into the apparatus shown in FIGS. 2(a)-(c). The apparatus 1 comprises a feed hopper 2 for the flaked coffee. The feed hopper 2 is cooled by a jacket carrying coolant at a temperature just above the dew point of the ambient air, typically 11-14° C. From the hopper 2, the flaked coffee is fed to the roller press 3. The roller press 3 is a Hosokawa Bepex Kompaktor K 200/50-50 briquetting press that comprises contra-rotating pocketed rollers 4, 5 each having sixty evenly spaced pockets (recesses) 8 around its circumference. The rollers 4, 5 are cooled by an internal loop carrying coolant at a temperature of about 14° C. The rollers rotate at about 10 rpm.

The resulting coffee compressed body 9 of coffee is shown in FIG. 3. It is in the shape of a finger having maximum dimensions approximately 5 cm×1 cm×0.5 cm and weight about 2.5 g.

The compressed bodies 9 formed in the roller press 3 drop into a hopper 6, which feeds into a a Hosokawa Bepex Flake Crusher FC200 7. The compressed coffee is immediately crushed in the flake crusher to give a compacted crushed coffee powder having a particle size distribution as shown in FIG. 1 with a maximum in the particle size distribution again at about 400 μm, but with an increased volume fraction of approximately 46% of fines having a size less than 100 μm. The tap density of the product is about 0.6 g/cm³.

The compacted and crushed coffee is introduced into a sachet 10 as shown in FIG. 4. This sachet comprises front and back faces of laminated film material incorporating polymer layers and an aluminium foil layer to provide gas- and moisture-impermeability. The layers are bonded around their edges 11. A water injection nozzle 12 is provided in a top edge of the sachet, and a bottom edge 13 of the sachet is sealed by means of a pressure-sensitive adhesive that opens under the influence of heat and pressure from inside the sachet when the beverage is brewed inside the sachet. A conventional filter sheet 14 is bonded to the inside of the sachet to retain the coffee grounds 15 inside the sachet during brewing. Full details of the construction and operation of such sachets are given in EP-A-0179641, referenced above.

The above embodiment has been described for the purpose of illustration only. Many other embodiments falling within the scope of the accompanying claims will be apparent to the skilled reader.

1. A process for the preparation of a coffee product comprising the step of compressing a roasted coffee in a roller press to form a compressed body of coffee.

2. A process according to claim 1, wherein the roasted coffee is a ground or flaked coffee.

3. A process according to claim 1, wherein external cooling is applied to the coffee prior to the step of compressing.

4. A process according to any preceding claim 1, wherein external cooling is applied to the coffee during the step of compressing.

5. A process according to claim 1, wherein the roller press comprises a profiled or pocketed roller.

6. A process according to claim 1, wherein the roller press comprises two pocketed rollers.

7. A process according to claim 1, wherein the compressed coffee has a density that is greater than 0.95 g/cm³.

8. A process according claim 1, further comprising the step of crushing the compressed body of coffee form a particulate coffee product.

9. A process according to claim 8, further comprising the step of packaging the particulate coffee in a brewing capsule.

10. A compressed body of coffee obtainable by a process comprising the step of compressing a roasted coffee in a roller press to form a compressed body of coffee.

11. A compressed body of coffee according to claim 10, wherein the compressed body of coffee does not have opposed flat faces.

12. A particulate coffee obtainable by a process comprising the steps of compressing a roasted coffee in a roller press to form a compressed body of coffee and crushing the compressed body of coffee to form a particulate coffee product.

13. A particulate coffee according to claim 12, wherein the particulate coffee has a particle size (e.g. D (4,3)) of from about 200 μm to about 600 μm.

14. A particulate coffee according to claim 12, wherein the particulate coffee has a tap density of greater than about 0.5 g/cm³.

15. A coffee brewing capsule containing a particulate coffee obtainable by a process comprising the steps of compressing a roasted coffee in a roller press to form a compressed body of coffee and crushing the compressed body of coffee to form a particulate coffee product for placement in a brewing capsule.
